(19) United States
(12) Patent Application Publication
(10) Pub. No.: US 2005/0125494 A1
(43) Pub. Date: Jun. 9, 2005

(54) System environment regulation violation detecting method for client device

(75) Inventors: Yasuhiro Horii, Tokyo (JP); Kenji Yamashiro, Tokyo (JP); Hiroshi Morita, Tokyo (JP)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Tsubasa System Co., Ltd.

(21) Appl. No.: 10/987,244

(22) Filed: Nov. 12, 2004

(30) Foreign Application Priority Data
Dec. 4, 2003 (JP) 2003-406410

(51) Int. Cl. H04L 9/00

(52) U.S. Cl. 709/203

(57) ABSTRACT

A system environment regulation violation detecting method for a client device, comprising a step of acquiring, by a mail client program read into a client device, regulation information containing regulations that should be met by a system environment of the client device, a step of detecting, by the mail client program, whether or not the system environment of the client device meets the regulations of the acquired regulation information, and a step of executing a predetermined process in accordance with a result of the detection. For example, the predetermined process is a process of deleting a predetermined file.

### BACKGROUND OF THE INVENTION

The invention relates to a technology for actualizing regulations such as a security policy, etc., in a client device at a comparatively low cost.

Over the recent years, there has been configured a system in which a client device such as a personal computer, etc., is connected to a network like a LAN, etc., and performs communications with other client devices or a variety of servers. In this type of system, it is a general practice in terms of ensuring the security that a security policy is settled, and the security is implemented in accordance with this policy. This category of policy is exemplified by the security prescribed by an information system field, etc., and is that, for example, virus checking software be installed into the client device connected to the network, a pattern file for searching for the virus be most-updated, free software with spyware hidden therein not be installed, and so on. Further, the software, etc., unrelated to the work should not be installed in terms of gaining high work efficiency.

Note that a technology for automatically collecting detailed information about the device connected to the network is disclosed in, e.g., Patent document 1.

[Patent document 1] Japanese Patent Application Laid-Open Publication No. 11-316724

### SUMMARY OF THE INVENTION

For ensuring the security, etc., according to the security policy, etc., however, a module called an agent had hitherto been installed into each client device (which is also termed a client machine), and a dedicated management server has hitherto been needed This leads to a problem that a large amount of cost is required for configuring the system. Besides, if a user deliberately uses unlawful software, a service might be stopped, or the software might be uninstalled.

It is an object of the invention to provide a technology for actualizing regulations such as a security policy, etc., in a client device at comparatively a low cost.

The invention is devised to solve the above problems and is a system environment regulation violation detecting method for a client device, comprising a step of acquiring, by a mail client program read into a client device, regulation information containing regulations that should be met by a system environment of the client device, a step of detecting, by the mail client program, whether or not the system environment of the client device meets the regulations of the acquired regulation information, and a step of executing a predetermined process in accordance with a result of the detection.

According to the invention, mainly the mail client program detects whether the regulations are met or not (a regulation violation detecting function), and it is therefore feasible to actualize the regulations such as a security policy, etc., in the client device at a lower cost than by providing the dedicated management server, etc., as in the prior art.

A reason why the regulation violation detecting function is thus incorporated into the mail client program (which may also called mail software) will be elucidated. The mail software is an indispensable item as a communication means utilized for the works when looking at the situation in these days. Namely, the mail software is frequently utilized for daily works and is therefore easy to assure the communications with the server. Accordingly, the regulation information (rule information) is easy to be kept in a most-updated state. Such being the case, according to the invention, the regulation violation detecting function is incorporated into the mail client program.

As far as the mail software is used for the works, however, the client device must have an environment where a given security policy prescribed in the information system field, etc., is maintained. So far as the mail client program according to the invention is utilized, it is possible to maintain the environment where the given security policy prescribed in the information system field, etc., and to prevent unlawful usage such as uninstalling and so on.

In the system environment regulation violation detecting method for the client device, the predetermined process is, for instance, a process of deleting a predetermined file. This is one example of the predetermined process. For instance, it is considered that a file proven (detected) not to meet the regulations is deleted from (a storage device, etc., of) the client device.

With this scheme, the file that does not meet the regulations can be automatically eliminated from the client device. The regulations that should be met by the system environment of the client device are thereby automatically met.

Further, in the system environment regulation violation detecting method for the client device, the predetermined process is a process of informing, if the regulations are not met, a user of this purport This is also one example of the predetermined process. For instance, if the application program that does not meet the regulations is installed, it is considered to inform that this program is to be deleted, and so on.

With this scheme, it is feasible to notify the user that the system environment of the client device does not meet the regulations. Moreover, the user recognizing this notification can be expected to take some action. It is considered from this that the regulations which should be met by the system environment of the client device are promptly met.

Further, in the system environment regulation violation detecting method for the client device, the predetermined process is a process of notifying an administrator device of the detection result This is also one example of the predetermined process. For instance, if it is detected that the regulations are not met and so on, it is considered that an administrator device is notified of this purport via an electronic mail etc.

This scheme enables a system administrator to grasp much sooner the client device that does not meet the regulations. Moreover, the administrator recognizing this notification can be expected to take some action. Hence, it is considered that the regulations which should be met by the system environment of the client device are promptly met.

Moreover, in the system environment regulation violation detecting method for the client device, the predetermined process is a process of restricting part of functions of the mail client program. This is also one example of the predetermined process. For instance, if it is detected that the regulations are not met, it is considered that part of the functions of the mail client program is restricted so that the mail can not be sent outside the client device.

This scheme makes it possible to reduce an influence in terms of security from being exerted on other client devices and a variety of servers.

Note that the predetermined processes given herein are just one examples. The predetermined process according to the invention is not limited to these processes.

Further, in the system environment regulation violation detecting method for the client device, the regulation information contains, as the regulation, at least one of specifying information for specifying a predetermined program that should be installed into the client device and an installing location where the predetermined program is installed.

This shows one example of the regulation information. The regulation information according to the invention is not confined to this example.

The invention can be specified by way of the invention of a program as follows.

A mail client program read into and executed by a client device, makes the client device execute a step of acquiring regulation information containing regulations that should be met by a system environment of the client device, a step of detecting, by the mail client program, whether or not the system environment of the client device meets the regulations of the acquired regulation information, and a step of executing a predetermined process in accordance with a result of the detection.

In the mail client program, the predetermined process is, for example, a process of deleting a predetermined file.

Further, in the mail client program, the predetermined process is, for instance, a process of informing, if the regulations are not met, a user of this purport.

Moreover, in the mail client program, the predetermined process is, for example, a process of notifying an administrator device of the detection result

Still further, in the mail client program, the predetermined process is, for instance, a process of restricting part of functions of the mail client program.

Yet further, in the mail client program, for example, the regulation information contains, as the regulation, at least one of specifying information for specifying a predetermined program that should be installed into the client device and an installing location where the predetermined program is installed.

Moreover, the invention can be specified by way of the invention of a server as below.

A server for receiving and forwarding a mail sent from the mail client program according to claim 7 which has been started by a client device, comprises means for restricting forwarding of mails sent from mail client programs other than the mail client program.

This scheme makes it possible to reduce the influence in terms of the security from being exerted on other client devices and the variety of servers.

According to the invention, it is feasible to actualize the regulations such as the security policy, etc., in the client device at comparatively a low cost.

### DESCRIPTION OF THE DRAWINGS

FIG. 1 is a diagram for explaining an outline of a system architecture for actualizing a system environment regulation violation detecting method for a client device by way of one embodiment of the invention.

FIG. 2 is a diagram for explaining the outline of the system architecture for actualizing the system environment regulation violation detecting method for the client device by way of one embodiment of the invention.

FIG. 3 is a sequence diagram for explaining an outline of an operation of the whole system shown in FIG. 1.

FIG. 4 is a flowchart for explaining an operation of a client device 100 in a way that puts a focus on this device 100.

FIG. 5 is a diagram for explaining an outline of (a modified example of) the system architecture for actualizing the system environment regulation violation detecting method for the client device by way of one embodiment of the invention.

### DETAILED DESCRIPTION OF THE INVENTION

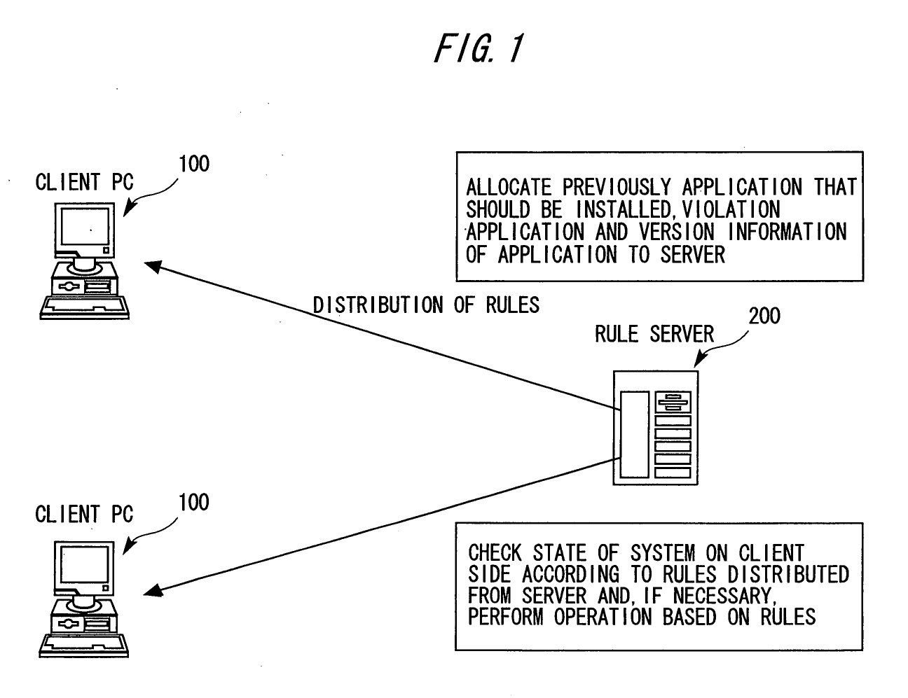

One embodiment of the invention will hereinafter be described with reference to the drawings. FIG. 1 is an explanatory diagram showing an outline of a system architecture for actualizing a system environment rule violation detection method of a client device by way of one embodiment of the invention.

(Architecture of Whole System)

As shown in FIG. 1, the system includes client devices 100 and a rule server 200. Note that the client device 100 is illustrated as a client PC. Further, FIG. 1 shows two pieces of client devices 100, however, this being an exemplification, as a matter of fact, a proper number of client devices 100 can be provided according to an application. The rule server 200 is illustrated like an independent server, however, this server can be also constructed in a way that serves as a mail server and so on (refer to modified examples that will be given later on).

(Outline of Configuration of Client Device 100)

The client device 100 is an information processing device such as a general type of personal computer and so forth, and includes a computer body, an image display device such as a liquid crystal display, a CRT display, etc., an input device such as a mouse, a keyboard, etc., a storage device such as a hard disc device, a memory (a RAM, a ROM and so on), etc., a reading device for reading storage information from a storage medium such as a memory card, a CD-ROM, etc., which are connected to the computer body, and a communication device (interface) for establishing a connection to a network (a communication line) such as a LAN (Local Area Network).

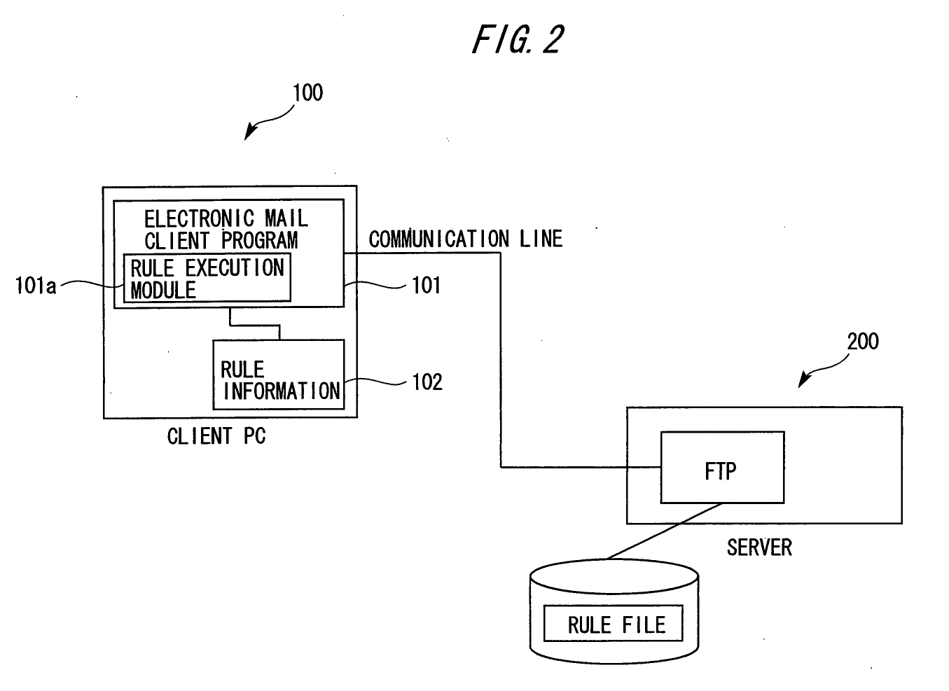

As shown in FIG. 2, the hard disc device is preinstalled with an electronic mail client program 101 and rule information (which may also be called regulation information) 102. Further, the hard disc device is preinstalled with, though not illustrated, a variety of programs such as an application program, an operating system, modified or added programs of these programs, a communication program for performing communications (based on, e.g., FTP (File Transfer Protocol)) via the network with the rule server 200, various pieces of data related to those programs, and so forth. Note that those programs and data are acquired through the reading device and the communication device and then installed. The electronic mail client program 101 connotes a program containing various categories of functions related to the electronic mail such as a creating/modifying function of a so-called e-mail text, etc., a storage management function of an already-transmitted mail, a received mail, etc., a management function (address book) of destination addresses, and so on. The electronic mail client program 101 may be structured regardless of whether this program contains those function as principal or additional functions For example, even in the case of an application program structured of mainly a so-called word processor function, this application program may be said to be the electronic mail client program 101 (corresponding to a mail client program according to the invention) on condition that the program contains part or the whole of the functions exemplified earlier.

(Outline of Configuration of Server 200)

As shown in FIG. 2, the rule server 200 manages the rule (regulation) information, containing rules (regulations) that should be met by a system environment of the client device 100, as a file-formatted (rule-file-formatted) database. Namely, the rule server 200 has the communication device (interface) for establishing the connection to the network (the communication line) such as the LAN, and the communication program for performing the communications (based on, e.g., FTP) via the network with the client devices 100. The rule server 200 provides the client devices 100 with the rule information managed by the server 200 itself, and so on. Further, the rule server 200 also manages the application program, etc., that should be installed into the client devices 100, and properly provides the application program, etc., to the client devices 100.

(Outline of Regulation Information)

The regulation information (which may also be referred to as the rule information) is information containing the regulations (that may also be called the rules) that should be met by the system environment of the client device 100. The regulations are exemplified such as pieces of specifying information (e.g., a program name and version information) for specifying a predetermined program such as the application program (including the file), the operation program (OS) information, etc., that should be (or should not be) installed into the client devices 100, an installing location (e.g., an address location on the storage device) of the predetermined program, or a method of detecting a program that violates these categories of information. The regulation information is stored as, for instance, script-formatted (file-formatted) information in the database managed by the rule server 200. In the rule server 200, the regulation information is updated (automatically or manually) by an administrator, etc., at a proper timing. The regulation information is updated, and therefore the client device 100 acquires the latest regulation information by properly accessing the rule server 200 (which will be described later on).

(Outline of Operation of Whole System)

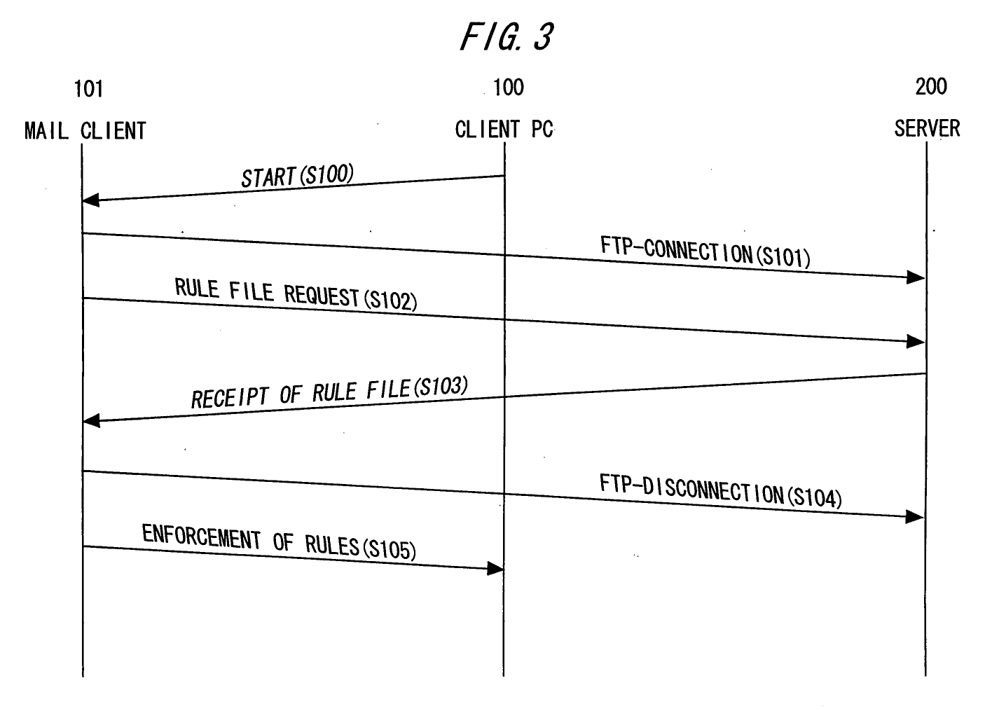

Next, an outline of the operation of the whole system explained above will be described with reference to the drawings. FIG. 3 is a sequence diagram for explaining the outline of the operation of the whole system. The processes shown in FIG. 3 are started by starting up the mail client program 101 on the client device 100 (S100).

Upon the start-up of the mail client program 101 (S100), mainly the mail client program 101 sends an FTP-connection request to the server 200 (S101). When the FTP-connection gets successful, the mail client program 101 transmits a request for the rule file (the regulation information) to the server 200 (S102). The server 200, upon receiving the rule file request, reads the rule file from the database and sends this file to the mail client program 101 as a requester.

The mail client program 101 receives (acquires) the rule file (S103) and installs (stores) this file into the storage device for the program 101 itself. The rule information shown in FIG. 2 is thus acquired. Note that it is judged whether the rule file managed by the serve 200 is updated or not, and, if not updated, it is preferable that downloading of the rule file be omitted. For example, if the rule file has previously been downloaded and already been installed on the self storage device on the client device 100, it is checked whether this rule file is a most-updated version or not In the case of the most-updated version, it is considered that the downloading is to be omitted. With this scheme, futile communications do not occur.

When the rule file is acquired in the manner described above, the mail client program 101 sends a request for cutting off the FTP-connection to the server 200 (S104). The FTP-connection is thereby cut off (disconnection). Then, the mail client program 101 enforces the rules (S105). Namely, the mail client program 101 detects (or judges) whether or not the system environment of the client device 100 meets the regulations of the rule information (corresponding to regulation information according to the invention) acquired a short while ago. This detection process will hereinafter be explained. Then, the mail client program 101 executes a predetermined process in accordance with a result of this detection. This predetermined process will also be explained later on.

(Operation of Client Device 100)

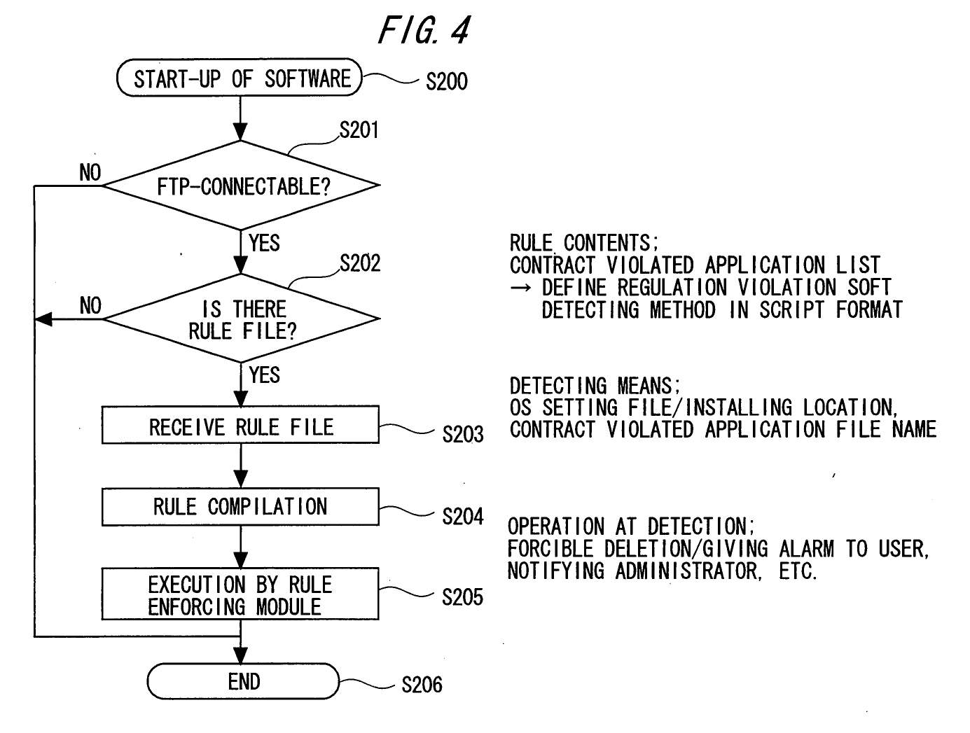

Next, a focus is put on the client device 100 in the system, and an operation thereof will be explained with reference to the drawings. FIG. 4 is an explanatory flowchart of the operation of the client device 100. Processes shown in FIG. 4 are started by starting up the mail client program 101 on the client device 100 (S200). Note that the following processes are executed mainly by the mail client program 101.

Upon the start-up of the mail client program 101 (S200), it is judged whether the FTP-connection can be established or not (S201). When judging from no response given from the rule server 200 that the FTP-connection can not be established (S201: No), the operation comes to an end without executing the processes from S202 onwards (S206). While on the other hand, when judging that the FTP-connection can be established (S206: Yes), i.e., when the FTP-connection gets successful, and, if the server 200 retains the rule file (the regulation information) (S202: Yes), the rule file is received (acquired) from the server 200 (S203). Whereas if the server 200 does not retain (S202: No), the operation is finished by executing none of the processes from S203 onwards (S206).

The rule file (the regulation information) is script-formatted in the embodiment, and hence the received rule file is compiled (S204) and executed (an execution by a rule enforcing module) (S205).

(Execution by Rule Enforcing Module)

Next, the execution by the rule enforcing module (S205) will be explained. This is a process for detecting (or judging) whether or not the system environment of the client device 100 meets the regulations (rules) of the regulation information received just earlier in S203. This process is executed mainly by a rule enforcing module (which may also be called a rule execution module) 101a incorporated into the mail client program 101.

As described above, the regulation information contains, as the regulations (rules), the specifying information (e.g., the program name and the version information) for specifying the predetermined program such as the application program, etc., the installing location (e.g., the address start location on the storage device) of the predetermined program, or the method of detecting the program that violates these categories of information.

The rule enforcing module 101a, based on the regulation information, searches for registry information and a file name in the operating system of the client device 100, and so on, thereby detecting whether or not the system environment of the client device 100 meets the regulations of the regulation information received just earlier in S203. For example, if the application program that should be installed is not yet installed, conversely if the application program that should not be installed has been installed, or if the application program has been installed in a location different from the location in which the application program should originally be installed, it is detected that the system environment does not meet the regulations of the regulation information.

The execution by the rule enforcing module (S205) is thus done, and it is detected (or judged) whether the regulations of the regulation information are met or not.

(Exemplification of Predetermined process)

As described above, when it is detected whether the regulations of the regulation information are met or not (S205), a predetermined process is executed according to a result of this detection. The following is an exemplification of this predetermined process. Selection of which predetermined process is to be executed is predefined in the regulation information, etc.

For instance, if the application program that should not be installed has been installed, it is detected through the rule enforcing module's execution that the regulations of the regulation information are not met (S205). In this case, the predetermined process involves executing a process of deleting (uninstalling) the application program that should not be installed from (the storage device of) the client device 100.

This enables the application program, etc., that does not meet the regulations to be automatically eliminated from the client device 100. Namely, the regulations that should be met by the system environment of the client device 100 are automatically met.

Further, if it is detected that the regulations of the regulation information are not thus met, the predetermined process may involve notifying the user of this purport. For instance, it is considered that this purport is displayed on the image display device. Moreover, when the client device 100 is provided with a voice output device, it is also considered that the purport is outputted from this voice output device. This makes it possible to notify the user that the system environment of the client device 100 does not meet the regulations. Further, it is also expected that the user recognizing this notification may take some action. It is therefore considered that the regulations which should be met by the system environment of the client device 100 are promptly met.

Further, the administrator device may also be notified of the result of the detection via the network, and so forth. For example, it is considered that a mail containing this purport, which is addressed to the administrator device, is delivered to this device. This scheme enables the system administrator to grasp much sooner the client device 100 that does not meet the regulations. Moreover, the administrator recognizing this notification can be expected to take some action. Hence, it is considered that the regulations which should be met by the system environment of the client device are promptly met.

Further, in the case of detecting that the regulations of the regulation information are not met as described above, the predetermined process may involve restricting part of the functions of the mail client program 101. For instance, it is considered that a transmitting function of the mail text is restricted.

This scheme makes it possible to reduce an influence in terms of security from being exerted on other client devices and a variety of servers.

As discussed above, according to the system environment regulation violation detecting method for the client device 100 in the embodiment, mainly the mail client program 101 (the rule execution module 101a) detects whether the regulations are met or not (a regulation violation detecting function). It is therefore feasible to actualize the regulations such as a security policy, etc., in the client device 100 at a lower cost than by providing the dedicated management server as in the prior art.

(Modified Example)

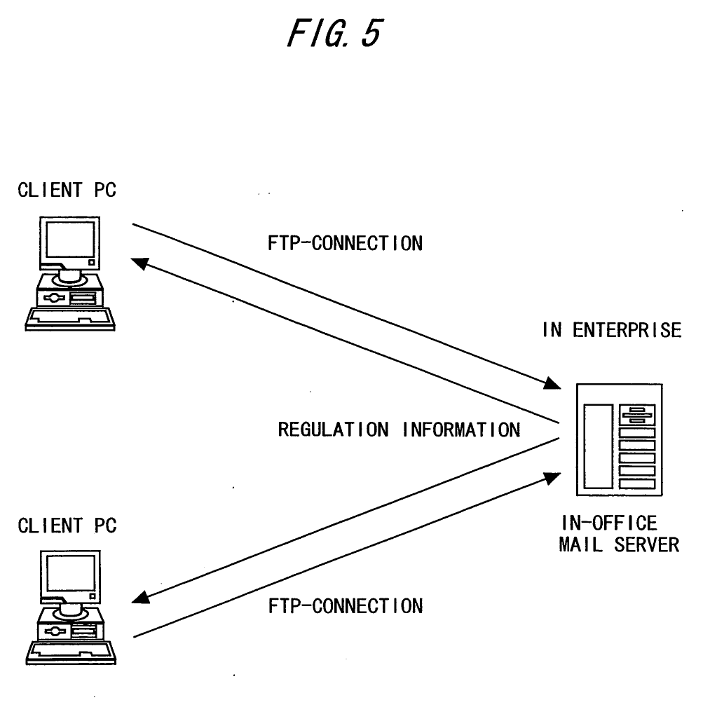

Next, a modified example of the embodiment will be explained referring to FIG. 5. FIG. 5 shows a system architecture into which the system architecture shown in FIG. 1 is partly modified. Specifically, the system architecture shown in FIG. 5 is that the mail server 200 among the components shown in FIG. 1 is replaced with an in-office mail server 300. Other configurations are the same as those shown in FIG. 1, and hence their explanations are omitted.

The in-office mail server 300 has a function as a general type of mail server, the function as the aforementioned mail server 200 and a function (a filtering function) that does not forward mails sent from mail client programs other than the mail client program 101. The last (filtering) function is actualized by a filtering module incorporated (installed) into the in-office mail server 300.

The filtering function is thus incorporated into the in-office mail server 300, and hence, even if the user tries to send a mail by installing a mail client program other than the mail client program 101 on the client device 100, the in-office mail server 300 restricts the forwarding of this mail. Namely, it is possible to restrict the forwarding of the mail even when the mail has been sent from the program different from the predetermined mail client program according to the invention. This can be judged from, e.g., a description of the running program that is contained in a mail header of the transmission mail. Owing to this scheme, the usage of the mail client program according to the invention can be unified Further, it is feasible to reduce the influence in terms of security from being exerted on other client devices 100 and the variety of servers as well.

The invention can be embodied in various forms without deviating from the spirit or the principal features thereof. Accordingly, the embodiment given above is just the exemplification in every aspect and should not be construed in a limited manner.

According to the invention, the regulations such as the security policy, etc., in the client device can be actualized at comparatively a low cost.

1. A system environment regulation violation detecting method for a client device, comprising:
a step of acquiring, by a mail client program read into a client device, regulation information containing regulations that should be met by a system environment of said client device;
a step of detecting, by said mail client program, whether or not the system environment of said client device meets the regulations of the acquired regulation information; and
a step of executing a predetermined process in accordance with a result of the detection.

2. A system environment regulation violation detecting method for a client device according to claim 1, wherein said predetermined process is a process of deleting a predetermined file.

3. A system environment regulation violation detecting method for a client device according to claim 1, wherein said predetermined process is a process of informing, if the regulations are not met, a user of this purport.

4. A system environment regulation violation detecting method for a client device according to claim 1, wherein said predetermined process is a process of notifying an administrator device of the detection result.

5. A system environment regulation violation detecting method for a client device according to claim 1, wherein said predetermined process is a process of restricting part of functions of said mail client program.

6. A system environment regulation violation detecting method for a client device according to claim 1, wherein said regulation information contains, as the regulation, at least one of specifying information for specifying a predetermined program that should be installed into said client device and an installing location where said predetermined program is installed.

7. A mail client program read into and executed by a client device, for mailing said client device execute:
a step of acquiring regulation information containing regulations that should be met by a system environment of said client device;
a step of detecting, by said mail client program, whether or not the system environment of said client device meets the regulations of the acquired regulation information; and
a step of executing a predetermined process in accordance with a result of the detection.

8. A mail client program according to claim 7, wherein said predetermined process is a process of deleting a predetermined file.

9. A mail client program according to claim 7, wherein said predetermined process is a process of informing, if the regulations are not met, a user of this purport.

10. A mail client program according to claim 7, wherein said predetermined process is a process of notifying an administrator device of the detection result.

11. A mail client program according to claim 7, wherein said predetermined process is a process of restricting part of functions of said mail client program.

12. A mail client program according to claim 7, wherein said regulation information contains, as the regulation, at least one of specifying information for specifying a predetermined program that should be installed into said client device and an installing location where said predetermined program is installed.

13. A server for receiving and forwarding a mail sent from said mail client program according to claim 7 which has been started by a client device, said server comprising: means for restricting forwarding of mails sent from mail client programs other than said mail client program.
